(19) United States
(12) Patent Application Publication
(10) Pub. No.: US 2026/0336465 A1
(43) Pub. Date: Oct. 29, 2026

(54) TRANSPORT SYSTEM AND TRANSPORT METHOD

(71) Applicant: SUBARU CORPORATION, Tokyo (JP)

(72) Inventors: Kensaku TANAKA, Tokyo (JP); Seiji KAWAGUCHI, Tokyo (JP)

(21) Appl. No.: 19/103,735

(22) PCT Filed: May 18, 2023
(86) PCT No.: PCT/JP2023/018579

§ 371 Date: Feb. 13, 2025

(51) Int. Cl. B60L 53/80; B60L 1/02; B60L 58/18

(52) U.S. Cl. CPC B60L 53/80; B60L 1/02; B60L 58/18; B60L 2200/36

(57) ABSTRACT

A transport system according to the present invention includes a temperature controlled box storing a delivery object therein, a transport vehicle configured to load and transport the temperature controlled box storing the delivery object therein, and a recipient facility that is a destination of the delivery object to be transported by the transport vehicle. A temperature control battery is chargeable by electricity supplied from an in-vehicle battery, and the in-vehicle battery is chargeable by electricity supplied from the temperature control battery.

### TECHNICAL FIELD

The present invention relates to a transport system that loads and transports a delivery object in a vehicle and also to a transport method.

### BACKGROUND ART

A method for transporting a delivery object to a destination by storing it in a temperature controlled box, which is used for cooling the inside of the temperature controlled box with supplied electricity, is known. For example, PTL 1 discloses a method for transporting a temperature controlled box storing a delivery object therein to a destination by using a vehicle provided with a cooling box.

### CITATION LIST

### Patent Literature

PTL 1: Japanese Unexamined Patent Application Publication No. 2023-8513

### SUMMARY OF INVENTION

### Technical Problem

It is desired that, during the transportation of a delivery object, electricity stored in an in-vehicle battery of a vehicle, such as an electric automobile or a hybrid automobile, be used for a purpose other than that for the vehicle. It is also desired that, after a delivery object is taken out of a temperature controlled box and is delivered, the remaining electricity of a temperature control battery built in the empty temperature controlled box be used for the vehicle.

The present invention proposes a transport system and a transport method for the effective use of electricity of an in-vehicle battery and that of a temperature control battery.

### Solution to Problem

A transport system according to the present invention includes a temperature controlled box, a transport vehicle, and a recipient facility. The temperature controlled box includes a storage, a temperature control device, and a temperature control battery. A space is provided in the storage by walls to store a delivery object therein. The temperature control device is configured to control a temperature of the space. The temperature control battery is configured to supply electricity to the temperature control device to operate the temperature control device. The transport vehicle includes an in-vehicle battery and is configured to load and transport the temperature controlled box storing the delivery object therein. The recipient facility is a destination of the delivery object to be transported by the transport vehicle. In a state in which the temperature controlled box is loaded in the transport vehicle, the temperature control battery is chargeable by electricity supplied from the in-vehicle battery, and the in-vehicle battery is chargeable by electricity supplied from the temperature control battery.

With this configuration, the in-vehicle battery and the temperature control battery can supply and receive electricity stored in the individual batteries to and from each other.

### Advantageous Effects of Invention

According to the present invention, electricity stored in the battery of a transport vehicle and that of a temperature controlled box can be effectively used.

### BRIEF DESCRIPTION OF DRAWINGS

FIG. 1 schematically illustrates a transport system of an embodiment.

FIG. 2 schematically illustrates the exterior of a temperature controlled box.

FIG. 3 schematically illustrates the overall functional configuration of the transport system.

FIG. 4 is a flowchart illustrating a transport method for use in the transport system.

FIG. 5 is a flowchart illustrating processing executed by a temperature control controller in the transport system.

FIG. 6 is a flowchart illustrating processing executed by a vehicle controller in the transport system.

### DESCRIPTION OF EMBODIMENTS

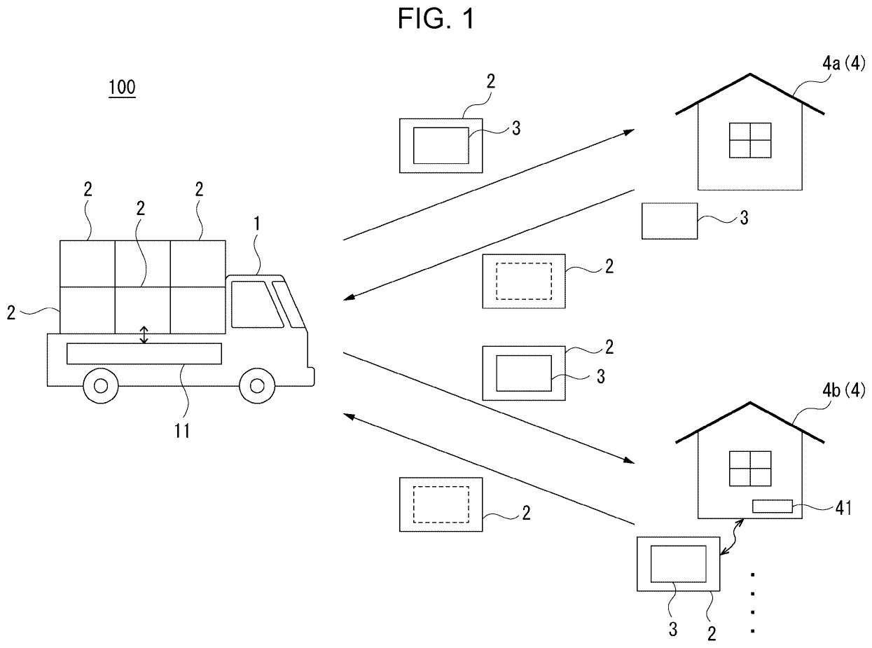

An embodiment will be described below with reference to FIGS. 1 through 6. In the drawings used for reference for an explanation of the embodiment, elements to carry out the embodiment and surrounding elements are selected and the configurations thereof are schematically illustrated. Concerning the individual structures illustrated in the drawings, the thicknesses, ratios, and relationships regarding the planar dimensions, for example, are merely examples and may be variously changed in accordance with various factors, such as the design, without departing from the technical concept of the invention.

A transport system 100 of the embodiment will be explained below with reference to FIGS. 1 through 3. As illustrated in FIG. 1, the transport system 100 includes a transport vehicle 1, temperature controlled boxes 2, delivery objects 3, and recipient facilities 4(4a, 4b, . . . ).

The transport vehicle 1 is, for example, an electric automobile including an in-vehicle battery 11 and driven by a drive force of a motor. The transport vehicle 1 may be another type of automobile, such as a hybrid automobile driven by a drive force of a motor or an engine. The motor of the transport vehicle 1 is driven by electricity supplied from the in-vehicle battery 11, and the tires of the transport vehicle 1 are rotated by the drive force of the motor.

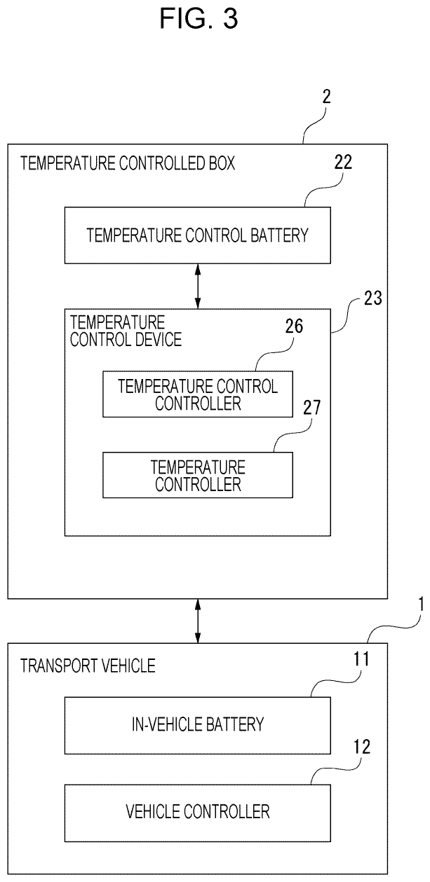

The transport vehicle 1 also includes a vehicle controller 12, as illustrated in FIG. 3. The vehicle controller 12 is a computer device including a microcomputer provided with a CPU (Central Processing Unit), a ROM (Read Only Memory), and a RAM (Random Access Memory), for example. As a result of the CPU executing processing in accordance with a program, the vehicle controller 12 controls various operations of the transport vehicle 1. The vehicle controller 12 performs control regarding the charging of the in-vehicle battery 11 and the supplying of electricity to a temperature controlled box 2, for example.

The transport vehicle 1 loads the temperature controlled boxes 2 storing the delivery objects 3 therein and delivers the delivery objects 3 to the recipient facilities 4 (4a, 4b).

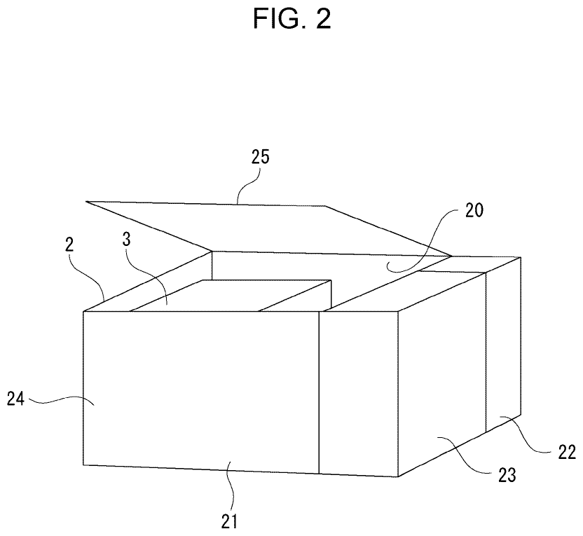

As illustrated in FIG. 2, the temperature controlled box 2 includes a storage 21, a temperature control battery 22, and a temperature control device 23. The storage 21, temperature control battery 22, and temperature control device 23 are attachable and removable from each other.

The storage 21 has walls 24 that form a space 20 and a cover 25 that opens and closes the space 20. A delivery object 3 is stored in the space 20 of the storage 21. Delivery objects 3 may be stored in the space 20.

The delivery object 3 is an object to be subjected to temperature control until it is delivered to a destination. For example, the delivery object 3 is to be kept cool or warm. In one example, the delivery object 3 is fresh food or frozen food to be kept cool. The delivery object 3 may be processed food to be kept warm. The delivery object 3 may be a product, such as a heat-sensitive electronic device.

The temperature control battery 22 is coupled to the temperature control device 23 and supplies electricity to the temperature control device 23 to operate it. The temperature control battery 22 is a rechargeable battery, for example. The temperature control battery 22 can be charged as a result of receiving the supply of electricity from the in-vehicle battery 11 of the transport vehicle 1. The temperature control battery 22 can also charge the in-vehicle battery 11 by supplying electricity.

For example, by coupling the temperature controlled box 2 to a charging device (not illustrated) provided in a load compartment (load platform) of the transport vehicle 1, the in-vehicle battery 11 and the temperature control battery 22 can supply and receive electricity stored in the individual batteries to and from each other. The temperature control battery 22 can be charged in a state in which it is separated from the temperature controlled box 2. For example, the temperature control battery 22, which is removed from the temperature controlled box 2, can be coupled to the charging device (not illustrated) provided in the transport vehicle 1 and be charged.

The temperature control device 23 includes a temperature control controller 26 and a temperature controller 27, as illustrated in FIG. 3. The temperature control controller 26 is a computer device including a microcomputer provided with a CPU, a ROM, and a RAM, for example. As a result of the CPU executing processing in accordance with a program, the temperature control controller 26 performs control regarding the operation of the temperature controller 27, charging of the temperature control battery 22, and supplying of electricity to the transport vehicle 1. The temperature control controller 26 of the temperature control device 23 and the vehicle controller 12 of the transport vehicle 1 can communicate with each other via a wired medium or a wireless medium.

The temperature controller 27 is coupled to the storage 21 and controls the temperature of the space 20. This can maintain the space 20 at a temperature suitable for the transportation of a delivery object 3.

The temperature controller 27 may include a known compression refrigeration cycle provided with a compressor, a condenser, an expansion valve, and an evaporator, for example. The temperature controller 27 may maintain the temperature of the space 20 by cooling the delivery object 3 stored in the storage 20 with this compression refrigeration cycle.

The recipient facilities 4 illustrated in FIG. 1 are destinations of the delivery objects 3 to be transported by the transport vehicle 1. The recipient facilities 4 include residences, service offices, and other facilities. A facility power source 41 is provided in the recipient facility 4 (4b). By coupling the temperature controlled box 2 to the facility power source 41, the temperature control battery 22 of the temperature controlled box 2 can receive the supply of electricity from the facility power source 41 and be charged.

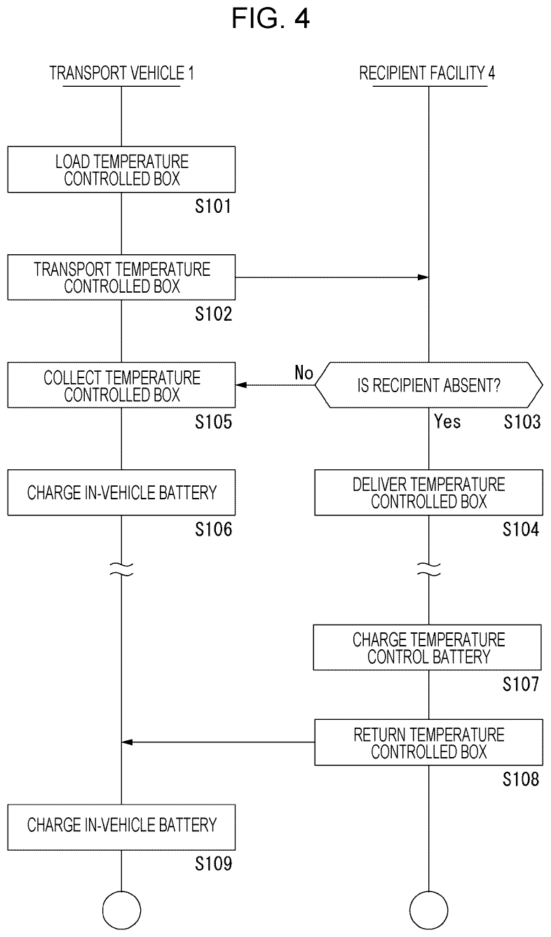

A transport method for use in the transport system 100 will be described below with reference to FIG. 4. First, in step S101, a temperature controlled box 2 storing a delivery object 3 therein is loaded in the load compartment (load platform) of the transport vehicle 1. One or more temperature controlled boxes 2 are loaded in the load compartment (load platform) by an operator (see FIG. 1).

In step S102, the transport vehicle 1 transports the temperature controlled boxes 2 storing the delivery objects 3 to the individual recipient facilities 4 (4a, 4b), which are delivery destinations. During the transportation, the temperature control device 23 is operated by receiving electricity of the temperature control battery 22 so that the space 20 of the storage 21 can be maintained at a temperature suitable for storing the delivery object 3 (see FIG. 2).

From step S101 to step S102, in a state in which the temperature controlled box 2 is loaded in the transport vehicle 1, the temperature control battery 22 can be charged using electricity supplied from the in-vehicle battery 11 of the transport vehicle 1.

Before the temperature controlled box 2 is loaded in the transport vehicle 1, it may be charged from an external power source (not illustrated) in advance. This does not waste the consumption of electricity of the in-vehicle battery 11 of the vehicle 1 to charge the temperature controlled box 2.

In step S103, for example, when the transport vehicle 1 arrives at a recipient facility 4 (recipient facility 4a in FIG. 1, for example), which is a delivery destination, the operator takes out the delivery object 3 from the temperature controlled box 2 and delivers it to a recipient in the recipient facility 4a.

After delivering the delivery object 3 to the recipient facility 4a, in step S105, the operator collects the used temperature controlled box 2 that no longer stores the delivery object 3 and loads it in the load compartment (load platform) of the transport vehicle 1.

In step S106, in a state in which the collected temperature controlled box 2 is loaded in the transport vehicle 1, the in-vehicle battery 11 of the transport vehicle 1 can be charged using electricity supplied from the temperature control battery 22 of the temperature controlled box 2. The charged electricity in the in-vehicle battery 11 can be used for driving the motor to run the transport vehicle 1, for example.

In step S103, for example, when the transport vehicle 1 arrives at a recipient facility 4 (recipient facility 4b in FIG. 1, for example), a recipient may be absent.

In this case, in step S104, the operator does not take out the delivery object 3 from the temperature controlled box 2 and delivers the whole temperature controlled box 2 to the recipient facility 4b. As a result of delivering the whole temperature controlled box 2, with the use of a temperature control function of the temperature control device 23 of the temperature controlled box 2, the space 20 of the storage 21 can be maintained at a temperature suitable for storing the delivery object 3 while the recipient is absent (see FIG. 2). This can prevent the delivery object 3 from spoiling or malfunctioning while the recipient is absent. After the completion of delivery, the transport vehicle 1 starts to move to the next recipient facility 4.

When the recipient returns to the recipient facility 4b, in step S107, he/she takes out the delivery object 3 from the temperature controlled box 2 and then charges the temperature control battery 22 by coupling the used temperature controlled box 2 to the facility power source 41 provided in the recipient facility 4b (see FIG. 1).

Then, in step S108, when the operator of the transport vehicle 1 drops in the recipient facility 4b next time, the recipient returns the charged temperature controlled box 2 to the operator. The returned temperature controlled box 2 is loaded in the load compartment (load platform) by the operator.

In step S109, in a state in which the collected temperature controlled box 2 is loaded in the transport vehicle 1, the in-vehicle battery 11 of the transport vehicle 1 can be charged using electricity supplied from the temperature control battery 22 of the temperature controlled box 2. The charged electricity in the in-vehicle battery 11 can be used for driving the motor to run the transport vehicle 1, for example. In step S109 proceeding from step S108, electricity from an external source (facility power source 41 of the recipient facility 4b) which is stored in the temperature control battery 22 can be used for running the transport vehicle 1, for example.

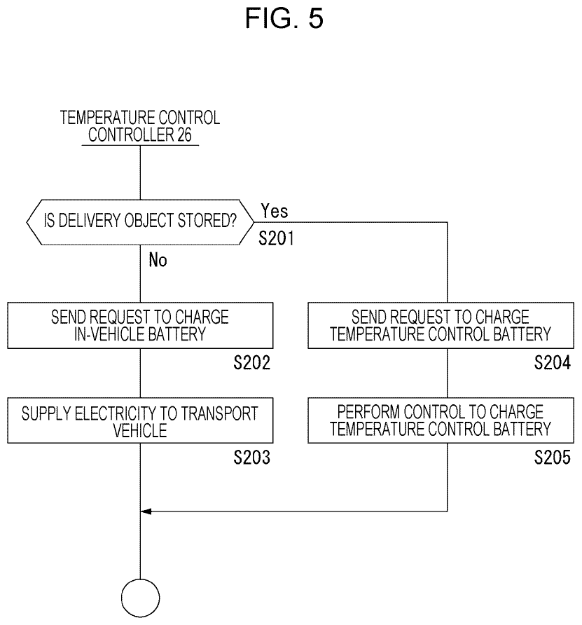

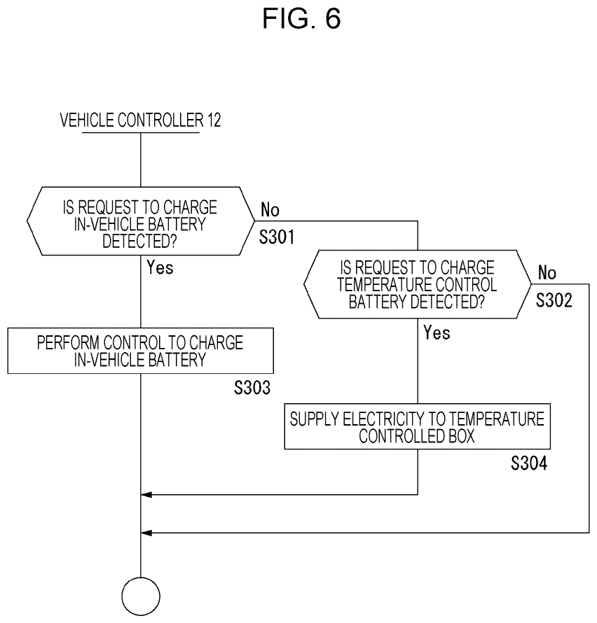

Processing operations executed by the temperature control controller 26 of the temperature controlled box 2 and by the vehicle controller 12 of the transport vehicle 1 in the transport system 100 will now be described below with reference to FIGS. 5 and 6. The processing operations illustrated in FIGS. 5 and 6 are executed in a state in which, for example, the temperature controlled box 2 is coupled to the charging device (not illustrated) of the transport vehicle 1 and the in-vehicle battery 11 and the temperature control battery 22 can supply and receive electricity stored in the individual batteries to and from each other.

Processing executed by the temperature control controller 26 of the temperature controlled box 2 will be explained below with reference to FIG. 5. First, in step S201, the temperature control controller 26 determines whether a delivery object 3 is stored in the storage 21 of the temperature controlled box 2. For example, various sensors (not illustrated), such as a weight sensor and an optical sensor, are disposed in the storage 2 to detect a delivery object 3 in the space 20. Based on detection information obtained from these sensors, the temperature control controller 26 determines whether a delivery object 3 is stored in the storage 21.

If it is determined in step S201 that a delivery object 3 is stored in the storage 21, the temperature control controller 26 proceeds to step S204. In step S204, the temperature control controller 26 sends a request to charge the temperature control battery 22 to the transport vehicle 1. Upon receiving this request, the transport vehicle 1 supplies electricity of the in-vehicle battery 11 to the temperature controlled box 2 (see S304 in FIG. 6, which will be discussed later).

Subsequently, in step S205, the temperature control controller 26 performs control to charge the temperature control battery 22 using electricity of the in-vehicle battery 11 supplied from the transport vehicle 1. With this control operation, the temperature control battery 22 can be charged in a state in which the temperature controlled box 2 storing the delivery object 3 is loaded in the transport vehicle 1. After step S205, the temperature control controller 26 completes the processing in FIG. 5.

If it is determined in step S201 that no delivery object 3 is stored in the storage 21, the temperature control controller 26 proceeds to step S202. In step S202, the temperature control controller 26 sends a request to charge the in-vehicle battery 11 to the transport vehicle 1.

Subsequently, in step S203, the temperature control controller 26 performs control to supply electricity of the temperature control battery 22 to the transport vehicle 1. In the transport vehicle 1, the in-vehicle battery 11 is charged using the supplied electricity of the temperature control battery 22 (see S303 in FIG. 6, which will be discussed later). After step S203, the temperature control controller 26 completes the processing in FIG. 5.

Processing executed by the vehicle controller 12 of the transport vehicle 1 will be explained below with reference to FIG. 6. First, in step S301, upon detecting a request to charge the in-vehicle battery 11 sent from the temperature controlled box 2 (see S202 in FIG. 5), the vehicle controller 12 proceeds to step S303.

Subsequently, in step S303, the vehicle controller 12 performs control to charge the in-vehicle battery 11 using electricity of the temperature control battery 22 supplied from the temperature controlled box 2 (see S203 in FIG. 5). With this control operation, in a state in which the used temperature controlled box 2 with no delivery object 3 is loaded in the transport vehicle 1, the in-vehicle battery 11 can be charged using the remaining electricity of the temperature control battery 22. After step S303, the vehicle controller 12 completes the processing in FIG. 6.

Upon detecting a request to charge the temperature control battery 22 sent from the temperature controlled box 2 (see S204 in FIG. 5), the vehicle controller 12 sequentially proceeds to steps S301, S302, and S304. In step S304, the vehicle controller 12 performs control to supply electricity of the in-vehicle battery 11 to the temperature controlled box 2. In the temperature controlled box 2, the temperature control battery 22 is charged using the supplied electricity of the in-vehicle battery 11 (see S205 in FIG. 5). After step S304, the vehicle controller 12 completes the processing in FIG. 6.

In the embodiment, the temperature control controller 26 executes the processing illustrated in FIG. 5 by way of example. However, the vehicle controller 12 may execute this processing. In this case, for example, the vehicle controller 12 acquires detection information obtained by various sensors from the temperature controlled box 2 and determines whether a delivery object 3 is stored in the temperature controlled box 2. If it is determined that a delivery object 3 is stored in the temperature controlled box 2, the vehicle controller 12 performs control to supply electricity from the in-vehicle battery 11 to charge the temperature control battery 22. If it is determined that no delivery object 3 is stored in the temperature controlled box 2, the vehicle controller 12 performs control to supply electricity from the temperature control battery 22 to charge the in-vehicle battery 11.

According to the above-described embodiment, a transport system 100 includes a transport vehicle 1, a temperature controlled box 2, and a recipient facility 4 (see FIG. 1). The transport vehicle 1 includes an in-vehicle battery 11 and loads and transports the temperature controlled box 2 storing a delivery object 3 therein. The temperature controlled box 2 includes a storage 21, a temperature control battery 22, and a temperature control device 23 (see FIG. 2). In the storage 21, a space 20 is provided by walls 24 to store a delivery object 3 therein. The temperature control battery 22 supplies electricity to the temperature control device 23 to operate it. The temperature control device 23 controls the temperature of the space 20. The recipient facility 4 is a destination of the delivery object 3 to be transported by the transport vehicle 1.

In a state in which the temperature controlled box 2 is loaded in the transport vehicle 1, the temperature control battery 22 can be charged using electricity supplied from the in-vehicle battery 11, and also, the in-vehicle battery 11 can be charged using electricity supplied from the temperature control battery 22 (see S101, S102, S106, S109 in FIG. 4 and see FIGS. 5 and 6, for example).

With this configuration, the in-vehicle battery 11 and the temperature control battery 22 can supply and receive electricity to and from each other. Hence, electricity stored in the individual batteries can be effectively used.

With the above-described configuration, in a state in which, for example, the temperature controlled box 2 storing a delivery object 3 therein is loaded in the transport vehicle 1, the temperature control battery 22 can be charged using electricity supplied from the in-vehicle battery 11 (see S101 and S102 in FIG. 4, S205 in FIG. 5, and S304 in FIG. 6, for example).

This can make it unnecessary to charge the temperature control battery 22 in advance by the use of electricity supplied from an external power source (not illustrated) before loading the temperature controlled box 2 in the transport vehicle 1, thereby enhancing the work efficiency of the operator of the transport system 100.

During the transportation using the transport vehicle 1, the temperature controlled box 2 operates the temperature control device 23 and thus consumes electricity to maintain the space 20 within the temperature controlled box 2 at a suitable temperature. At this time, supplying electricity from the in-vehicle battery 11 to charge the temperature control battery 22 can prevent a shortage of electricity in the temperature control battery 22 during the transportation in the transport vehicle 1. This can prevent a stoppage of temperature control in the temperature controlled box 2, which would be caused by the electricity shortage during the transportation in the transport vehicle 1, and can thus prevent the delivery object 3 stored in the temperature controlled box 2 from spoiling or malfunctioning.

With the above-described configuration, in a state in which, for example, the temperature controlled box 2 that does not store a delivery object 3 is loaded in the transport vehicle 1, the in-vehicle battery 11 can be charged using electricity supplied from the temperature control battery 22 (see S106 and S109 in FIG. 4, S203 in FIG. 5, and S303 in FIG. 6, for example).

For instance, after a delivery object 3 is delivered to the recipient facility 4 (4a), the remaining electricity of the temperature control battery 22 of the empty temperature controlled box 2 is supplied to the in-vehicle battery 11 and is used for driving the motor to run the transport vehicle 1, for example. This can increase the cruising distance of the transport vehicle 1.

If the whole temperature controlled box 2 is delivered to the recipient facility 4 (4b), it is possible that the temperature control battery 22 be charged using electricity supplied from the facility power source 41 and then the temperature controlled box 2 be collected from the recipient facility 4 (4b) (see FIG. 1).

In this case, the in-vehicle battery 11 can be charged using electricity supplied from the charged temperature control battery 22 (see S109 in FIG. 4). More electricity can thus be supplied to the in-vehicle battery 11, thereby further increasing the cruising distance of the transport vehicle 1.

In the embodiment, in one example, the collected temperature controlled box 2 is used for charging the in-vehicle battery 11 with electricity supplied from the temperature control battery 22. Alternatively, the collected temperature controlled box 2 may be reused by storing another delivery object 3 therein.

The transport method for use in the transport system 100 of the embodiment is implemented by all or some of steps S101 through S109 in FIG. 4. The processing operations illustrated in FIGS. 5 and 6 may be implemented as a program to be executed by the CPUs of the vehicle controller 12 and the temperature control controller 26, for example.

The advantages discussed in the disclosure are only examples. The disclosure is not limited to these advantages and may achieve other advantages. The disclosure may achieve some of the advantages discussed in the disclosure. Not all the combinations of the configurations discussed in the embodiment are necessarily essential to solve the above-described problems.

### REFERENCE SIGNS LIST

1 transport vehicle
2 temperature controlled box
3 delivery object
4, 4a, 4b recipient facility
11 in-vehicle battery
20 space
21 storage
22 temperature control battery
23 temperature control device
41 facility power source

1. A transport system comprising:
a recipient facility, which is a destination of a delivery object;
a temperature controlled box comprising a storage, a temperature control device, and a temperature control battery, a space being provided in the storage by walls to store the delivery object therein, the temperature control device being configured to control a temperature of the space, the temperature control battery being configured to supply electricity to the temperature control device to operate the temperature control device, the temperature controlled box being deliverable to the recipient facility in a state in which the delivery object is stored in the temperature controlled box; and
a transport vehicle comprising an in-vehicle battery and being configured to load and transport the temperature controlled box storing the delivery object therein,
wherein, in a state in which the temperature controlled box is loaded in the transport vehicle,
the temperature control battery is chargeable by electricity supplied from the in-vehicle battery, and
the in-vehicle battery is chargeable by electricity supplied from the temperature control battery.

2. The transport system according to claim 1, wherein, in a state in which the temperature controlled box storing the delivery object therein is loaded in the transport vehicle, the temperature control battery is charged using electricity supplied from the in-vehicle battery.

3. The transport system according to claim 1, wherein, in a state in which the temperature controlled box that does not store the delivery object therein is loaded in the transport vehicle, the in-vehicle battery is charged using electricity supplied from the temperature control battery.

4. The transport system according to claim 1, wherein:
the recipient facility comprises a facility power source that is configured to supply electricity to the temperature control battery to charge the temperature control battery; and
in a state in which the temperature controlled box comprising the temperature control battery which is charged by electricity supplied from the facility power source is loaded in the transport vehicle, the in-vehicle battery is charged using electricity supplied from the temperature control battery.

5. A transport method for use in a transport system, the transport system comprising a temperature controlled box, a transport vehicle, and a recipient facility, the recipient facility being a destination of a delivery object, the temperature controlled box comprising a storage, a temperature control device, and a temperature control battery, a space being provided in the storage by walls to store the delivery object therein, the temperature control device being configured to control a temperature of the space, the temperature control battery being configured to supply electricity to the temperature control device to operate the temperature control device, the temperature controlled box being deliverable to the recipient facility in a state in which the delivery object is stored in the temperature controlled box, the transport vehicle comprising an in-vehicle battery and being configured to load and transport the temperature controlled box storing the delivery object therein, the recipient facility being a destination of the delivery object to be transported by the transport vehicle,
the transport method comprising:
a step of transporting the temperature controlled box storing the delivery object therein to the recipient facility by loading the temperature controlled box in the transport vehicle;
a step of collecting the temperature controlled box which no longer stores the delivery object therein and loading the temperature controlled box in the transport vehicle after delivering the delivery object to the recipient facility; and
a step of charging the in-vehicle battery using electricity supplied from the temperature control battery of the collected temperature controlled box.

6. The transport system according to claim 2, wherein, in a state in which the temperature controlled box that does not store the delivery object therein is loaded in the transport vehicle, the in-vehicle battery is charged using electricity supplied from the temperature control battery.

7. The transport system according to claim 2, wherein:
the recipient facility comprises a facility power source that is configured to supply electricity to the temperature control battery to charge the temperature control battery; and
in a state in which the temperature controlled box comprising the temperature control battery which is charged by electricity supplied from the facility power source is loaded in the transport vehicle, the in-vehicle battery is charged using electricity supplied from the temperature control battery.
